(19) United States
(12) Patent Application Publication
(10) Pub. No.: US 2026/0361392 A1
(43) Pub. Date: Nov. 12, 2026

(54) COMMUNICATION SYSTEMS

(71) Applicant: Axon Capital AI Limited, London (GB)

(72) Inventors: Nicholas D'ALOISIO-MONTILLA, London (GB); Ayush SHAH, London (GB)

(73) Assignee: Axon Capital AI Limited, London (GB)

(21) Appl. No.: 19/215,881

(22) Filed: May 22, 2025

(30) Foreign Application Priority Data
May 12, 2025 (GB) 2507278.6

(51) Int. Cl. H04B 7/185

(52) U.S. Cl. CPC H04B 7/1851

(57) ABSTRACT

A relay station for transmitting data from a first computer to a second computer includes at least two low earth orbit satellite transceivers and a relay computer system arranged to relay signals received via a first low earth orbit satellite transceiver from a first low earth orbit satellite onto a second low earth orbit satellite via a second low earth orbit satellite transceiver. The relay computer system is arranged to: a) receive first IP packets from the first computer via the first low earth orbit satellite transceiver; b) produce corresponding second IP packets addressed to an IP address of the second computer; and c) transmit the second IP packets via the second low earth orbit satellite transceiver towards the second computer.

This invention relates to communication systems, in particular communication systems which are used for transmitting data between computer systems.

In such systems there are various parameters of the communication channel which are of interest, one of these is latency, ie the delay between the transmission of data and its reception at the desired location. Reducing or minimising latency is generally desirable but there can be particular use cases where reduced latency is of particular interest. These include situations where there is a live real-world element to the data being transmitted. This may, for example, be data that relates to a two way conversation or interaction, live transmission of video data, data involved in transactions based on real-world events and so on.

When such data is sent externally between different sites or entities, the use of the Internet for transmitting such data is, of course, commonplace. However the amount of latency that may be introduced into the overall communication channel when using the internet can vary greatly depending on the underlying infrastructure of the internet and via what route the data carrying signals are routed. Signals routed over cables, for example fibre optic cables running under the ocean, will generally see higher latency than those carried by say microwave signals, or radio signals, or inter-satellite laser signals. Whilst in theory a private dedicated data channel could be provided from A to B to minimise the latency between two points, this is generally prohibitively complex and/or expensive in practice for any large scale use.

It can also be noted that at least some elements of internet infrastructure have routing rules or algorithms which look to conserve bandwidth or guard against drop offs in performance which might occur if lossy or limited bandwidth routes are used too extensively. Consider the example of a low earth orbit (LEO) satellite communications system. These typically comprises a mesh or constellation of satellites that can communicate with each other and a network of ground stations which are integrated with the general Internet infrastructure and arranged to communicate with the satellites. LEO satellite communications providers may look to use ground based cables, say parts of the general internet infrastructure, to carry signals where available to control the amount of traffic carried in the LEO satellite constellation and/or to control the number of hops taken satellite to satellite to avoid degradation in the signals which may occur with too many such hops. Of course, a typical user of such systems will have no control over those routing algorithms and rather needs to work within the technical constraints which they create.

It would be desirable to provide a system that aims to minimise latency experienced by data transmitted over Internet infrastructure whilst taking into account existing routing algorithms.

According to a first aspect of the present invention there is provided a communication system for transmitting data from a first computer to a second computer comprising:
a low earth orbit satellite communications system comprising a plurality of low earth orbit satellites arranged to communicate with each other and with ground based low earth orbit satellite transceivers;
a relay station comprising at least two low earth orbit satellite transceivers which are arranged for communication with the plurality of low earth orbit satellites and a relay computer system arranged to relay signals received via a first of the at least two low earth orbit satellite transceivers from a first low earth orbit satellite in the plurality of low earth orbit satellites onto a second low earth orbit satellite in the plurality of low earth orbit satellites via a second of the at least two low earth orbit satellite transceivers;
wherein,
i) the relay station is disposed at a geographical location selected to facilitate reception of signals from the first low earth orbit satellite in the plurality of low earth orbit satellites via the first of the at least two low earth orbit satellite transceivers and transmission of signals to the second low earth orbit satellite in the plurality of low earth orbit satellites via the second of the at least two low earth orbit satellite transceivers;
ii) the first computer is arranged under the control of software to produce first IP packets carrying data items and addressed to an IP address associated with the first of the at least two low earth orbit satellite transceivers at the relay station;
iii) the relay computer system is arranged under the control of software to:
a) receive the first IP packets via the first of the at least two low earth orbit satellite transceivers,
b) produce corresponding second IP packets carrying the respective data items but addressed to an IP address of the second computer,
c) transmit the second IP packets via the second of the at least two low earth orbit satellite transceivers towards the second computer;
and
iv) the second computer is arranged to receive the second IP packets.

Such arrangements recognize that low latency can be achieved by making use of LEO satellite communication systems but that these tend to be governed by routing algorithms that route signals through ground based cables where available. It has been found that latency reductions can be achieved by the provision of a relay station located so as to drive the use of the LEO satellites in two arms of the communications channel on either side of the relay station whilst also controlling the number of satellite to satellite hops that are included in the channel.

It has been found for example that locating such a relay station in the Atlantic ocean, or an island in the Atlantic ocean, can be useful in reducing latency in signaling between say the US and the UK. In such a case when the longitude at which the relay station is located is suitably selected it can lead to the relay station communicating with a first satellite in one arm of the communication channel and a second satellite in the other arm of the communication channel where the first satellite is closer to the UK than is the second satellite. In some such cases the first satellite may itself communicate with a ground station in the UK and the second satellite may itself communicate with a ground station in the US. In other similar cases there may be intermediate hops between satellites on the way to respective ground stations.

According to another aspect of the present invention there is provided a relay station for use in a communication system for transmitting data from a first computer to a second computer,
the relay station comprising at least two low earth orbit satellite transceivers which are arranged for communication with a plurality of low earth orbit satellites and a relay computer system arranged to relay signals received via a first of the at least two low earth orbit satellite transceivers from a first low earth orbit satellite in the plurality of low earth orbit satellites onto a second low earth orbit satellite in the plurality of low earth orbit satellites via a second of the at least two low earth orbit satellite transceivers;
wherein the relay computer system is arranged under the control of software to:
a) receive first IP packets carrying data items originating from the first computer via the first of the at least two low earth orbit satellite transceivers,
b) produce corresponding second IP packets carrying the respective data items but addressed to an IP address of the second computer, and
c) transmit the second IP packets via the second of the at least two low earth orbit satellite transceivers towards the second computer.

According to a further aspect of the present invention there is provided a relay station for use in a communication system according to the first aspect of the invention,
the relay station comprising at least two low earth orbit satellite transceivers which are arranged for communication with a plurality of low earth orbit satellites and a relay computer system arranged to relay signals received via a first of the at least two low earth orbit satellite transceivers from a first low earth orbit satellite in the plurality of low earth orbit satellites onto a second low earth orbit satellite in the plurality of low earth orbit satellites via a second of the at least two low earth orbit satellite transceivers;
wherein the relay computer system is arranged under the control of software to:
a) receive first IP packets carrying data items originating from the first computer via the first of the at least two low earth orbit satellite transceivers,
b) produce corresponding second IP packets carrying the respective data items but addressed to an IP address of the second computer, and
c) transmit the second IP packets via the second of the at least two low earth orbit satellite transceivers towards the second computer.

In each case in use the relay station can be disposed at a geographical location selected to facilitate reception of signals from the first low earth orbit satellite in the plurality of low earth orbit satellites via the first of the at least two low earth orbit satellite transceivers and transmission of signals to the second low earth orbit satellite in the plurality of low earth orbit satellites via the second of the at least two low earth orbit satellite transceivers.

The provision of such relay stations allows the implementation of the present type of communication system.

According to yet another aspect of the present invention there is provided a first computer for use in a communication system for transmitting data from a first computer to a second computer, the communication system comprising:
a low earth orbit satellite communications system comprising a plurality of low earth orbit satellites arranged to communicate with each other and with ground based low earth orbit satellite transceivers;
a relay station comprising at least two low earth orbit satellite transceivers which are arranged for communication with the plurality of low earth orbit satellites and a relay computer system arranged to relay signals received via a first of the at least two low earth orbit satellite transceivers from a first low earth orbit satellite in the plurality of low earth orbit satellites onto a second low earth orbit satellite in the plurality of low earth orbit satellites via a second of the at least two low earth orbit satellite transceivers;
wherein the relay station is disposed at a geographical location selected to facilitate reception of signals from the first low earth orbit satellite in the plurality of low earth orbit satellites via the first of the at least two low earth orbit satellite transceivers and transmission of signals to the second low earth orbit satellite in the plurality of low earth orbit satellites via the second of the at least two low earth orbit satellite transceivers;
and wherein the first computer is arranged under the control of software to produce first IP packets carrying data items and addressed to an IP address associated with the first of the at least two low earth orbit satellite transceivers at the relay station.

According to yet another aspect of the present invention there is provided a first computer for use in a communication system according to the first aspect of the invention wherein the first computer is arranged under the control of software to produce first IP packets carrying data items and addressed to an IP address associated with the first of the at least two low earth orbit satellite transceivers at the relay station.

According to yet another aspect of the present invention there is provided a first computer for use in a communication system for transmitting data from a first computer to a second computer, wherein the first computer is arranged under the control of software to produce first IP packets carrying data items for transmission to the second computer and addressed to an IP address associated with a relay station which is disposed in a communication channel between the first computer and the second computer and which is disposed at a geographical location selected to facilitate reception of signals from a first low earth orbit satellite via a first low earth orbit satellite transceiver at the relay station and transmission of signals to a second low earth orbit satellite via a second low earth orbit satellite transceiver at the relay station.

According to yet another aspect of the present invention there is provided a method of sending data from a first computer to a second computer, comprising the steps, at the first computer, of producing first IP packets carrying data items for transmission to the second computer and addressed to an IP address associated with a relay station which is disposed in a communication channel between the first computer and the second computer and which is disposed at a geographical location selected to facilitate reception of signals from a first low earth orbit satellite via a first low earth orbit satellite transceiver at the relay station and transmission of signals to a second low earth orbit satellite via a second low earth orbit satellite transceiver at the relay station; and
sending the first IP packets.

According to yet another aspect of the present invention there is provided a second computer for use in a communication system for transmitting data from a first computer to a second computer, the communication system comprising:
a low earth orbit satellite communications system comprising a plurality of low earth orbit satellites arranged to communicate with each other and with ground based low earth orbit satellite transceivers;
a relay station comprising at least two low earth orbit satellite transceivers which are arranged for communication with the plurality of low earth orbit satellites and a relay computer system arranged to relay signals received via a first of the at least two low earth orbit satellite transceivers from a first low earth orbit satellite in the plurality of low earth orbit satellites onto a second low earth orbit satellite in the plurality of low earth orbit satellites via a second of the at least two low earth orbit satellite transceivers;
wherein the relay station is disposed at a geographical location selected to facilitate reception of signals from the first low earth orbit satellite in the plurality of low earth orbit satellites via the first of the at least two low earth orbit satellite transceivers and transmission of signals to the second low earth orbit satellite in the plurality of low earth orbit satellites via the second of the at least two low earth orbit satellite transceivers;
wherein the relay computer system is arranged under the control of software to:
a) receive first IP packets carrying data items originating from the first computer via the first of the at least two low earth orbit satellite transceivers,
b) produce corresponding second IP packets carrying the respective data items but addressed to an IP address of the second computer, and
c) transmit the second IP packets via the second of the at least two low earth orbit satellite transceivers towards the second computer;
and wherein the second computer is arranged under the control of software to receive the second IP packets.

According to yet another aspect of the present invention there is provided a second computer for use in a communication system according to the first aspect of the invention wherein the second computer is arranged under the control of software to receive the second IP packets.

According to yet another aspect of the present invention there is provided a method of receiving data at a second computer from a first computer, comprising the step of receiving second IP packets carrying data from a relay station which is disposed in a communication channel between the first computer and the second computer and which is disposed at a geographical location selected to facilitate reception of signals from a first low earth orbit satellite via a first low earth orbit satellite transceiver at the relay station and transmission of signals to a second low earth orbit satellite via a second low earth orbit satellite transceiver at the relay station, the second IP packets carrying data from the first computer having been received at the relay station via first IP packets.

It will be appreciated that in practical systems there may be, and likely will be, communication in both directions between the first and second computers. Thus the above features can be considered with the roles of the first and second computers, the first and second transceivers at the relay station, and the first and second satellites reversed.

Thus, in a development the communication system is also for transmitting data from the second computer to the first computer,
the relay computer system is arranged to relay signals received via a second of the at least two low earth orbit satellite transceivers from the second low earth orbit satellite in the plurality of low earth orbit satellites onto the first low earth orbit satellite in the plurality of low earth orbit satellites via the first of the at least two low earth orbit satellite transceivers;
wherein,
i) the relay station is disposed at a geographical location selected to facilitate reception of signals from the second low earth orbit satellite in the plurality of low earth orbit satellites via the second of the at least two low earth orbit satellite transceivers and transmission of signals to the first low earth orbit satellite in the plurality of low earth orbit satellites via the first of the at least two low earth orbit satellite transceivers;
ii) the second computer is arranged under the control of software to produce third IP packets carrying data items and addressed to an IP address associated with the second of the at least two low earth orbit satellite transceivers at the relay station;
iii) the relay computer system is arranged under the control of software to:
a) receive the third IP packets via the second of the at least two low earth orbit satellite transceivers,
b) produce corresponding fourth IP packets carrying the respective data items but addressed to an IP address of the first computer,
c) transmit the fourth IP packets via the first of the at least two low earth orbit satellite transceivers towards the first computer;
and
iv) the first computer is arranged to receive the fourth IP packets.

Similarly, in a development of the relay station,
the relay computer system is arranged to relay signals received via the second of the at least two low earth orbit satellite transceivers from a second low earth orbit satellite in the plurality of low earth orbit satellites onto the first low earth orbit satellite in the plurality of low earth orbit satellites via the first of the at least two low earth orbit satellite transceivers;
wherein the relay computer system is arranged under the control of software to:
a) receive third IP packets carrying data items originating from the second computer via the second of the at least two low earth orbit satellite transceivers,
b) produce corresponding fourth IP packets carrying the respective data items but addressed to an IP address of the first computer, and
c) transmit the fourth IP packets via the first of the at least two low earth orbit satellite transceivers towards the first computer.

It will be seen that each of the other statements written above relating to communication from the first computer to the second computer could be re-written to be directed to communication from the second computer to the first computer, and these form part of the present ideas but these are not written here in full merely in the interest of brevity.

In modified arrangements where there are more than two satellite transceivers provided on the relay station, then a first set may be used for communications in one direction and a second set may be used for communications in the second, opposite direction. In such a case third and fourth satellite transceivers at the relay station may be used in place of the first and second satellite transceivers respectively in the above defined bi-directional arrangements.

The relay station may comprise a main body. The relay station may comprise a transceiver positioning system for positioning at least one of the low earth orbit satellite transceivers relative to the main body.

The transceiver positioning system may comprise at least one of:
a translational positioning mechanism for moving the at least one of the low earth orbit satellite transceivers translationally relative to the main body;
a rotational positioning mechanism for rotating the at least one of the low earth orbit satellite transceivers relative to the main body around a rotation axis; and
a tilt positioning mechanism for tilting the at least one of the low earth orbit satellite transceivers relative to the main body around a tilt axis.

The rotation axis may be selected so as to be generally perpendicular to a plane occupied by the main body. The tilt axis may be selected so as to be generally parallel to a plane occupied by the main body.

The rotation axis may be selected so as to be generally perpendicular to the tilt axis.

The transceiver positioning system may be arranged for positioning each of the low earth orbit satellite transceivers relative to the main body.

The translational positioning mechanism may be arranged for moving each of the low earth orbit satellite transceivers translationally relative to the main body.

The rotational positioning mechanism may be arranged for rotating each of the low earth orbit satellite transceivers relative to the main body around respective rotation axes.

The tilt positioning mechanism may be arranged for tilting each of the low earth orbit satellite transceivers relative to the main body around respective tilt axes.

The transceiver positioning system may comprise at least one motor and at least one motor control unit for controlling operation of the at least one motor.

The translational positioning mechanism may comprise at least one respective motor.

The rotational positioning mechanism may comprise at least one respective motor.

The tilt positioning mechanism may may comprise at least one respective motor.

The relay station may be arranged as a platform which is arranged to be provided in the ocean. In this case the body of the relay station may comprise a main deck of the platform.

The platform may be arranged to float in the ocean. The platform may be arranged to be tethered to the seabed. The platform may be arranged to be anchored to the seabed such that it does not float but rather is supported by the anchoring system.

The relay station may be arranged as a vehicle—say a waterborne vehicle or a ground based vehicle. The vehicle may be an autonomous vehicle.

The relay station may comprise a propulsion system for moving the relay station translationally relative to a surface on which it supported. This may be a seawater, ie ocean, surface or a land surface.

The relay station may comprise a propulsion system control unit for controlling operation of the propulsion system.

In alternatives the relay station may be arranged as a static ground based structure.

The relay station may comprise at least one solar panel for providing electrical power to components of the relay station.

The relay station computer system may be arranged under the control of software to act as a central control system for controlling at least one of:
the transceiver positioning system; and
the propulsion system.

The relay station computer system may comprise a plurality of relay station computers, say a first relay station computer and a second relay station computer.

The first relay station computer may be arranged for receiving signals acquired by the first of the at least two low earth orbit satellite transceivers. The first relay station computer may be arranged for sending signals via the first of the at least two low earth orbit satellite transceivers.

The second relay station computer may be arranged for sending signals via the second of the at least two low earth orbit satellite transceivers. The second relay station computer may be arranged for receiving signals acquired by the second of the at least two low earth orbit satellite transceivers.

The IP address associated with the first of the at least two low earth orbit satellite transceivers may be the IP address of the first relay station computer.

The IP address associated with the second of the at least two low earth orbit satellite transceivers may be the IP address of the second relay station computer.

The relay station computer system may be arranged under the control of software to act as a central control system for controlling at least one of:
the transceiver positioning system;
the propulsion system,
so as to at least one of move and orient at least one of the low earth orbit satellite transceivers in dependence on a model of position versus time of the plurality of low earth orbit satellites in order to facilitate communication between the at least one of the low earth orbit satellite transceivers and a selected one of the low earth orbit satellites in preference to another of the low earth orbit satellites.

This can help ensure that the respective transceiver is in communication with the desired satellite to minimise the latency of the respective arm of the communications channel—specifically say to direct the signals from the respective transceiver towards a satellite which is nearer to the UK, than an alternative satellite, when the second computer is in the UK.

Preferably, the relay station computer system is arranged under the control of software to act as a central control system for controlling at least one of:
the transceiver positioning system;
the propulsion system,
so as to at least one of move and orient the first and second low earth orbit satellite transceivers in dependence on a model of position versus time of the plurality of low earth orbit satellites in order to:
i) facilitate communication between the first satellite transceiver and a first selected one of the low earth orbit satellites in preference to a second selected one of the low earth orbit satellites; and
ii) facilitate communication between the second satellite transceiver and the second selected one of the low earth orbit satellites in preference to the first selected one of the low earth orbit satellites.

This can help ensure that the respective transceivers are in communication with the desired satellites to minimise the latency of the respective arms of the communications channel—specifically say to receive signals at the first satellite transceiver from a first satellite and to direct the signals from the second satellite transceiver towards a second satellite which is nearer to the UK, than the first satellite, when data is to be sent say from US to UK.

Alternatively or additionally the relay station computer system may be arranged under the control of software to act as a central control system for controlling at least one of:
the transceiver positioning system;
the propulsion system,
so as to at least one of move and orient at least one of the low earth orbit satellite transceivers by:
a) at a first time monitoring via which ones of the plurality of low earth orbit satellites are used to send signals to and/or receive signals from the first satellite transceiver and the second satellite transceiver; and
b) at a second time at least one of moving and orienting at least one of the low earth orbit satellite transceivers when said monitoring reveals that signals were being sent to and/or received from the first satellite transceiver and the second satellite transceiver via the same low earth orbit satellite, said at least one of moving and orienting being specified with the aim of:
i) facilitating communication between the first satellite transceiver and a first selected one of the low earth orbit satellites in preference to a second selected one of the low earth orbit satellites; and
ii) facilitating communication between the second satellite transceiver and the second selected one of the low earth orbit satellites in preference to the first selected one of the low earth orbit satellites.

This can again help ensure that the respective transceivers are in communication with the desired satellites to minimise the latency of the respective arms of the communications channel—specifically say to receive signals at the first satellite transceiver from a first satellite and to direct the signals from the second satellite transceiver towards a second satellite which is nearer to the UK, than the first satellite, when data is to be sent say from US to the UK. This approach is using a feedback loop arrangement rather than relying on modelling information as in technique described further above. If desired both forms of control could be used.

In some cases there may be hops between satellites in one or other arms of the communication channel. In other cases there may be just one respective satellite used in one or both arms of the communication channel. It does not matter which of these occurs-what is of interest is that communication from the relay station heads off in what one might call “opposite” directions. This helps ensure that signals are taking a lower latency path than if ground based/subsea cables were used to carry the signals.

In yet further developments a plurality of relay station modules may be provided for use together as a relay station, with each relay station module comprising at least one of the satellite transceivers. Each relay station module may be arranged for communication with other respective relay station modules. In such cases data received via the a satellite receiver in the first IP packets at a first relay station module may be passed to a second relay station module for inclusion in the second IP packets which are sent from the second relay station module.

Such relay station modules may be arranged to send data to other relay station modules via radio or microwave signals. Each relay station module may comprises its own body portion, and say be arranged to float or be tethered separately from other relay station modules.

This can facilitate greater physical separation between receiving and sending satellite transceivers.

Each relay station module may comprise respective elements of the transceiver positioning system. Each relay station module may comprise respective elements of the propulsion system.

In some instances the first computer may be the ultimate origination point of the data to be transmitted to the second computer. In other instances the data to be transmitted may ultimately originate elsewhere with the first computer acting as an intermediate location.

In such a case the communication system may comprise an origination computer arranged under the control of software to:
identify data to be sent from the origination computer via the relay station; and
send that data to the first computer.

Further the first computer may be arranged to receive said data from an origination computer for use in generating the first IP packets.

Similarly, in some instances the second computer will be the ultimate destination of the data to be transmitted from the first computer. In other instances the data to be transmitted may have an ultimate destination beyond the second computer, with the second computer acting as an intermediate location.

In such a case the communication system may comprise a destination computer.

The second computer may be arranged under the control of software to:
identify data received via second IP packets which are to be sent to a destination computer; and
send that data to the destination computer.

According to another aspect of the present invention there is provided a computer program comprising code portions which when loaded and run on a computer device or set of computer devices cause the computer device or set of computer devices to execute a method as one of a communication system, a first computer, a second computer, an origination computer, a destination computer, a relay station computer system, a first relay station computer, a second relay station computer as defined above and/or cause the computer device to constitute one of a communication system, a first computer, a second computer, an origination computer, a destination computer, a relay station computer system, a first relay station computer, a second relay station computer as defined above.

According to another aspect of the present invention there is provided a machine readable data carrier carrying a computer program as defined above. The carrier in this case may include a signal.

According to another aspect of the present invention there is provided at least one machine readable physical media product carrying a computer program as defined above. Examples of a machine readable physical media product include a hard drive, a SSD, a DVD, a flash memory drive and so on.

In this specification the expressions computer, computer device, and computer system are used to refer to physical pieces of equipment arranged for running software. The computers, computer devices, and computer systems on which the present invention can be embodied will typically include at least a processor, memory and data storage. More generally each computer, computer device, or computer system will include an arrangement of conventional parts of computers such as Memory, Hard Drive or Solid State Drive, Video card, Motherboard, Processor, Power Supply, Output devices—Monitor/screen, speakers/headphone connection, Input devices—keyboard, mouse, touch screen and so on.

Note that, in general terms and with any necessary modifications in wording, all of the further features defined above following any aspect of the invention above are applicable as further features of all other aspects of the invention defined above. These further features are not restated after each aspect of the invention merely for the sake of brevity.

Embodiments of the present invention will now be described, by way of example only, with reference to the accompanying drawings in which:

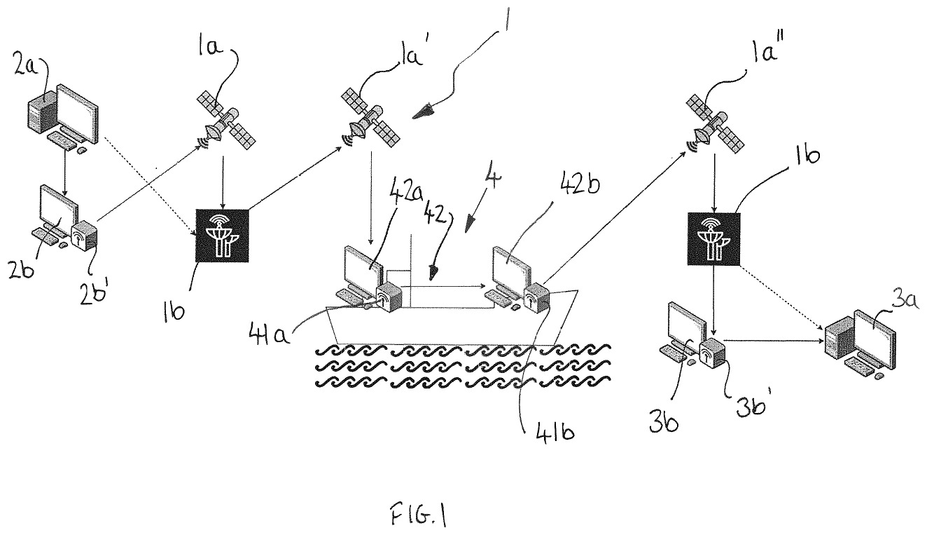

FIG. 1 schematically shows a communication system;

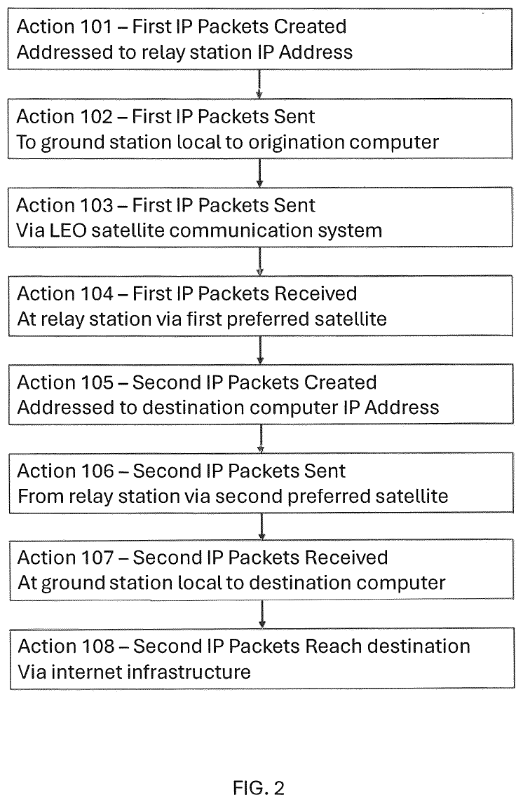

FIG. 2 is a flow chart showing processes that occur in the communication system of FIG. 1;

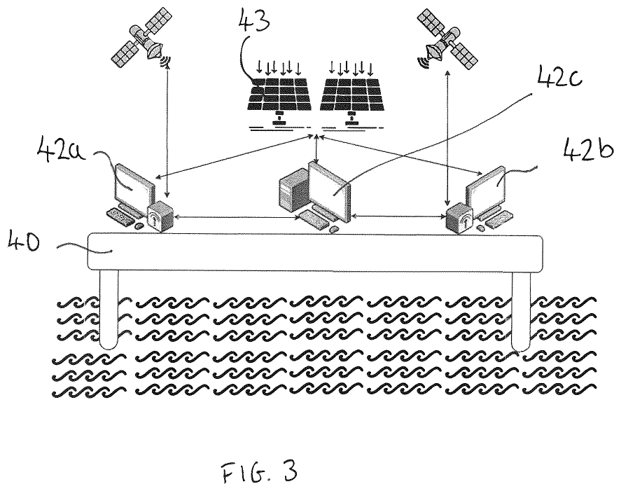

FIG. 3 schematically shows a relay station of the communication system of FIG. 1;

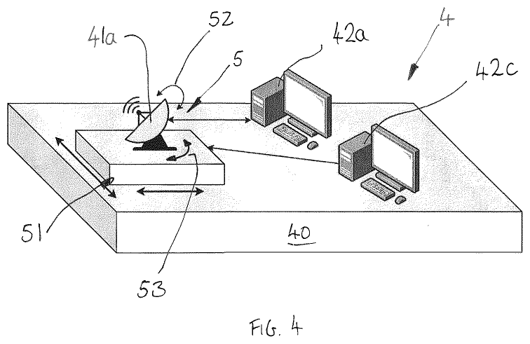

FIG. 4 schematically shows part of the relay station of FIG. 3 illustrating a transceiver positioning system of the relay station;

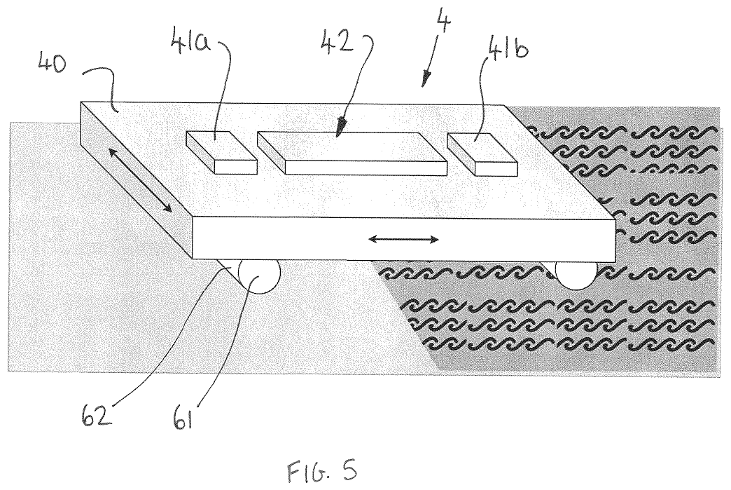

FIG. 5 schematically shows the relay station of FIG. 3 illustrating a propulsion system of the relay station; and

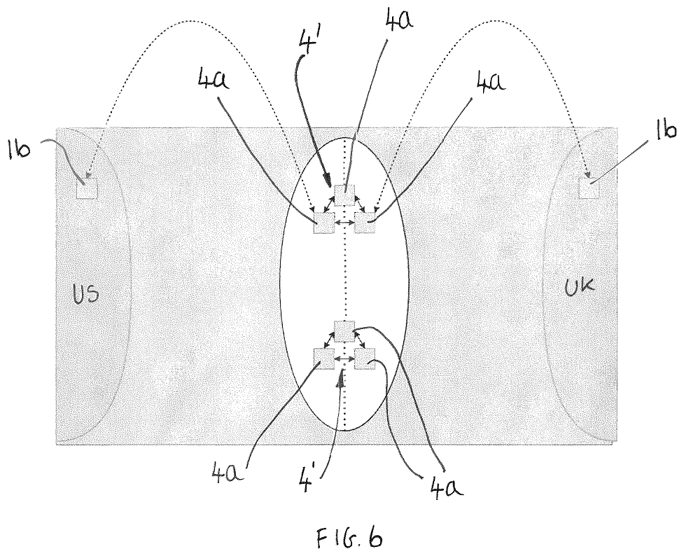

FIG. 6 schematically shows a modified form of the communication system which includes relay stations made up of relay station modules which combine together to act as relay stations.

FIG. 1 schematically shows a communication system which comprises a low earth orbit (LEO) satellite communications system 1 comprising a plurality of low earth orbit satellites 1a arranged in a mesh and a plurality of ground stations 1b. The communication system further comprises an originating computer 2a and a first intermediate computer 2b as well as a destination computer 3a and a second intermediate computer 3b. As will be explained in more detail below the communication system is arranged for sending data from the originating computer 2a to the destination computer 3a. In fact the communication system is also arranged for sending data from the destination computer 3a to the originating computer 2a, though for the sake of clarity this description first will focus on data transmission from the originating computer 2a to the destination computer 3a.

A communication channel exists between the originating computer 2a and the destination computer 3a which includes the LEO satellite communications system 1. Also provided in this communication channel is a relay station 4. The relay station 4 comprises at least two LEO satellite communication transceivers 41a, 41b and is arranged for communicating with, in effect interfacing with, the LEO satellite communications system 1. The relay station 4 comprises a relay station computer system 42. The relay station computer system comprises a first relay station computer 42a having a first IP address and which is arranged for communicating via a first of the LEO satellite communication transceivers 41a, and a second relay station computer 42b having a second IP address and which is arranged for communicating via a second of the LEO satellite communication transceivers 41b.

Communication between the ground station 1b in the region of the originating computer 2a and/or the first intermediate computer 2b may be via general internet infrastructure and/or via the LEO satellite communication system 1. Communication between the ground station 1b in the region of the destination computer 3a and/or the second intermediate computer 3b may be via general internet structure and/or via the LEO satellite communication system 1.

It has been found by the applicants that at predetermined geographical locations, in particular at predetermined longitudes, regions can be found where a small change in position or orientation of a LEO satellite communication transceiver will cause connection to a different LEO satellite which will lead to signals leading away from the transceiver in opposite directions. Thus the relay station 4 can be positioned such that there are two branches of the communication channel away from it via the LEO satellite communication system—one via the first 41a satellite communication transceiver and one via the second satellite communication transceiver 41b. Moreover, in at least some cases this can lead to signals in one direction reaching a ground station on one land mass/continent and signals in the other direction reaching a ground station on another land mass/continent. Such a relay station 4 located in the Atlantic say can then facilitate low latency communications between say the UK and the US.

Suitable locations can be determined by monitoring/determining where signals to/from a LEO satellite communication transceiver switch to using ground stations on different desired land masses. Between US and UK there are suitable longitudes at around 34.2 degrees West and a suitable location for a relay station might be say 52.6081° N, 34.2224° W. In this scenario signals might leave/enter North America via a ground station in Canada, say in Halifax.

Correspondingly one aspect of the present ideas is a method for determining suitable locations for positioning of the present type of relay station 4, which includes the step of determining locations where signals to/from a LEO satellite communication transceiver switch from being routed via a ground station on a first land mass to being routed via a ground station on a second land mass.

In the communications system shown in FIG. 1 data to be sent from the originating computer 2a to the destination computer 3a may take one of two different routes at the start of its journey.

In a first option first IP packets carrying desired data items may be created at the origination computer 2a and addressed to the first IP address—ie that of the first relay station computer 42a. These first IP packets will then make their way via general internet infrastructure to the local ground station 1b.

In a second option data items to be sent from the origination computer 2a are first sent to the first intermediate computer 2b. This may be carried out using initial IP packets created by the origination computer 2a, addressed to an IP address of the first intermediate computer 2b and carried over the internet. Alternatively the data may be transmitted to the first intermediate computer 2b by other means—say via a private network. Either way at the first intermediate computer 2b first IP packets carrying the desired data items are created and addressed to the first IP address—ie that of the first relay station computer 42a. In the present embodiment, the first intermediate computer 2b has an associated satellite communication transceiver 2b′ and transmits the first IP packets via this to an LEO satellite 1a via which they reach the local ground station 1b.

In the first option the origination computer 2a plays role of “the first computer” in the presently defined inventions. In the second option the first intermediate computer 2b plays role of “the first computer” in the presently defined inventions.

From the local ground station 1b, the first IP packets are transmitted via the LEO satellite communication system 1 to the relay station 4, in particular the first relay station computer 42a via the first relay station satellite transceiver 41a.

At the relay station 4, the relay station computer system 42 generates second IP packets carrying the respective data items carried by the first IP packets but addressed to one of:
i) an IP address of the destination computer 3a according to a first option;
ii) an IP address of the second intermediate computer 3b according to a second option.

These second IP packets are transmitted by the second relay station computer 42b via the second relay station satellite transceiver 41b to the LEO satellite communication system 1.

Via this route the second IP packets reach the ground station 1b local to the destination computer 3a and/or the second intermediate computer 3b.

From there the second IP packets reach the destination computer 3a either directly via general internet infrastructure in the above mentioned first option, or via the second intermediate computer 3b in the above mentioned second option.

In the first option the destination computer 3a plays role of “the second computer” in the presently defined inventions. In the second option the second intermediate computer 3b plays role of “the second computer” in the presently defined inventions.

The same arrangement may be used for transmitting data in the opposite direction. In this case the destination computer 3a or second intermediate computer 3b creates and sends third IP packets carrying data items and addressed to the second IP address ie that of the second relay station computer 42b associated with the second satellite transceiver 41b at the relay station 4. Then at the relay station 4, the third IP packets are received via the second satellite transceiver 41b and the relay station computer system 42 produces and sends corresponding fourth IP packets carrying the respective data items but addressed to an IP address of the first intermediate computer 2b or the originating computer 2a.

In a practical example, the originating computer may be based in the US and the destination computer 3a in the UK, with the relay station 4 in the Atlantic as mentioned above.

FIG. 2 shows a flow chart of the processes that occur in operation of the present communication system in sending data from the originating computer 2a to the destination computer 3a in the case where the first and second intermediate computers 2b and 3b are not used.

In Action 101 first IP packets carrying desired data items are created at the origination computer 2a and addressed to the first IP address—ie that of the first relay station computer 42a. The origination computer 2a plays role of “the first computer” in the presently defined inventions.

In Action 102 these first IP packets make their way via general internet infrastructure to the local ground station 1b.

In Action 103 the first IP packets are transmitted via the LEO satellite communication system 1 to the relay station 4.

In Action 104 the first IP packets are received at the first relay station computer 42a via the first relay station satellite transceiver 41a receiving signals from a first preferred satellite 1a′.

In Action 105, at the relay station 4, the relay station computer system 42 generates second IP packets carrying the respective data items carried by the first IP packets but addressed to an IP address of the destination computer 3a.

In Action 106, these second IP packets are transmitted by the second relay station computer 42b via the second relay station satellite transceiver 41b to a second preferred satellite 1a″ in the LEO satellite communication system 1.

In Action 107, the second IP packets reach the ground station 1b local to the destination computer 3a via the LEO satellite communication system.

In Action 108, the second IP packets reach the destination computer 3a via general internet infrastructure. The destination computer 3a plays role of “the second computer” in the presently defined inventions.

As mentioned above the same arrangement may be used for transmitting data in the opposite direction, but this is not shown in the flow chart.

FIG. 3 shows the relay station 4 in isolation. The relay station 4 comprises a main body 40 which in this embodiment is a deck of a platform with supports the other components of the relay station 4. This platform may be arranged to float in water—say in the ocean—and may be arranged to be tethered to the seabed.

In alternatives the relay station 4 may comprise a platform which is arranged to be anchored to the seabed—in some such cases, the anchoring arrangement may support the relay station such that is does not float. In other cases the relay station may be embodied in a vehicle, such as an autonomous vehicle—which may be land based, water based or amphibious, or arranged to be provided on such a vehicle or vessel. In each such case the relay station 4 will have a body 40.

As shown in FIG. 3 the relay station computer system 42 in this embodiment comprise a central relay station computer 42c which is connected to the first and second relay station computers 42a, and 42b and controls their operation as well as the overall operation of the relay station 4. In the present embodiment the central relay station computer 42c is arranged to generate the second IP packets and the fourth IP packets.

The relay station 4 also comprises at least one solar panel 43 for providing power to the components of the relay station 4.

Referring to FIG. 4 which shows part of the relay station 4, the relay station 4 comprises a transceiver positioning system 5 for moving the satellite transceivers 41a, 41b relative to the main body 40. In this embodiment the transceiver position system 5 is arranged for independently moving each of the satellite transceivers 41a, 41b relative to the main body 40. FIG. 4 shows only the first satellite transceiver 41a for simplicity's sake.

The transceiver positioning system 5 comprises:
translational positioning mechanisms 51 (only one of which is shown) for moving the satellite transceivers 41a, 41b translationally relative to the main body;
rotational positioning mechanisms 52 (only one of which is shown) for rotating the satellite transceivers 41a, 41b relative to the main body around respective rotation axes; and
tilt positioning mechanisms 53 (only one of which is shown) for tilting the satellite transceivers 41a, 41b relative to the main body around respective tilt axes.

The translational, rotational and tilt positioning mechanisms 51, 52, 53 comprise respective motors (not shown) which are arranged under the control of the relay station computer system 42, in this case specifically the central relay station computer 42c.

The relay station computer system 42 may be arranged under the control of software to control the transceiver positioning system, in particular the motors of the translational, rotational and tilt positioning mechanisms 51, 52, 53, to position one or both of the satellite transceivers 41a, 41b with the aim of ensuring that they communicate with the desired satellites 1a′, 1a″ to obtain the desired form of communication channel.

In some sets of embodiments the relay station computer system 42 is arranged to carry out this control in dependence on a model of the position of satellites 1a in the LEO communications system versus time. This model can contain information on the position of the satellites and their expected route to ground station based on position and/or based on prior determination of their route to ground station. This model may be built and stored at the relay station computer system 42 or built elsewhere and provided to the relay station. The model may be updated dynamically—either by computation at the relay station computer system 42 or computation elsewhere and delivery to the relay station 4.

In some sets of embodiments the relay station computer system 42 is arranged to carry out this control in dependence on a feedback loop. In such a case the relay station computer system 42 is arranged to:
a) at a first time monitor via which ones of the plurality of low earth orbit satellites 1a are used to send signals to and/or receive signals from the first satellite transceiver 41a and the second satellite transceiver 41b; and
b) at a second time at least one of move and orient at least one of the low earth orbit satellite transceivers 41a, 41b when said monitoring reveals that signals were being sent to and/or received from the first satellite transceiver and the second satellite transceiver via the same low earth orbit satellite (or otherwise at least one non-desirable satellite 1a) so as to ensure they communicate via the desired satellites 1a′, 1a″.

In other embodiments both above techniques of modelling and feedback may be used.

In each case the aim is:
i) facilitating communication between the first satellite transceiver 41a and a first selected one of the low earth orbit satellites 1a′ in preference to a second selected one of the low earth orbit satellites 1a″; and
ii) facilitating communication between the second satellite transceiver 41b and the second selected one of the low earth orbit satellites 1a″ in preference to the first selected one of the low earth orbit satellites 1a′.

As well as the facility to move and orient the satellite transceivers 41a, 41b relative to the body 40 of the relay station 4 to assist in obtaining communications via the desired satellites 1a′, 1b′, as mentioned above, in some sets of embodiments the relay station 4 is arranged as vehicle—typically an autonomous vehicle—arranged for moving on the surface on which it is provided. For example, the vehicle may be a land based vehicle, a water based vehicle, or an amphibious vehicle.

FIG. 5 schematically illustrates the relay station 4 as an autonomous vehicle—in this case an amphibious vehicle. Such a relay station 4 still has or can have all of the features described above including a transceiver positioning system 5 but also includes a propulsion system 6 for moving the relay station 4 wholesale relative to the surface on which it is provided. The other features of the relay station 4 are not shown in detail in FIG. 5 just for the sake of simplicity.

The propulsion system 6 comprises at least one drive unit 61 for causing moving of the relay station 4 and an associated control unit 62. The drive units may comprise propeller based thrusters, motor driven wheels and so on, depending on the type of surface(s) over which the relay station is designed to operate. The overall operation of the propulsion system 6 is controlled by the relay station computer system 42 for controlling the position of the relay station 4.

Again the primary aim behind moving the relay station 4 with this propulsion system 6 is to position the satellite transceivers 41a, 41b with the aim of having them communicate with the desired satellites 1a′, 1a″.

Again the relay station computer system 42 may be arranged for causing such movement in dependence on the above described model based technique and/or the above described feedback based technique.

Furthermore the relay station 4 may be arranged to accept movement instructions for the transceiver positioning system 5 and/or the propulsion system 6 from a user. These might be received from a remote location via one of the satellite transceivers 41a, 41b or via another route, such as via local manually operated controls and/or another wireless connection.

In a further development rather than one relay station 4 made up of an integral body 40 carrying two satellite transceivers 41a, 41b which are both used in the communication channel, a more distributed form of relay station 4′ may be provided as illustrated in FIG. 6.

FIG. 6 schematically shows two such relay stations 4′ each of which is made up of three respective relay station modules 4a which co-operate together as a relay station 4′.

Each relay station module 4a includes a body portion.

In some cases each relay station module 4a may have the same structure and components as the relay station 4 shown in FIGS. 1 to 5. In other cases the relay station module 4a may itself comprise only some of the parts of the overall relay station 4′. Thus, in particular, a relay station module 4a may comprise only one satellite transceiver 41a or 41b, and may comprise the computer 42a or 42b associated with its transceiver 41a or 41b, but not the other one. In this way the relay station computer system 42 may be distributed across the relay station modules 4a. There might be one central relay station computer 42c provided on one of the modules 4a.

Overall the distributed relay station 4′ operates in the same way as the relay station 4 of FIGS. 1 to 5 from an external point of view. There is still communication between one satellite 1a′ and the first transceiver 41a, and between another satellite 1a″ and the second transceiver 41b. Moreover first IP packets are received and relayed on as second IP packets, and third IP packets are received and relayed on as fourth IP packets.

However, internally the relay station modules 4a co-operate to give this effect.

Each relay station module 4a also comprises a local transceiver (not shown)—say a radio or microwave transceiver—for communicating with the other relay station modules 4a in the relay station 4. This enables co-ordination of operation. Further these transceivers are used to transmit the data payload from the first IP packets which is to be transmitted as second IP packets and similarly the data payload from the third IP packets which is to be transmitted as fourth IP packets between the relay station modules 4a where one set of packets is received at one of the modules 4a and is to be transmitted from another of the modules 4a.

As one example of operation, the receiving relay station module 4a of the first IP packets may generate the second IP packets and transmit these via the local transceivers for onwards transmission by the relay station module 4a which is to send the packets onwards.

The relay station modules 4a may be provided in a static arrangement with spacing between the modules 4a chosen to facilitate communication with the desired satellites 1a′, 1a″.

In other embodiments, the relay station modules 4a may be arranged for movement relative to one another and together may comprise a propulsion system 6 of the type shown in FIG. 5.

In either such case a transceiver positioning system 5 can be provided and each module 4a may comprise respective transceiver positioning mechanisms 51, 52, 53 of the type shown in FIG. 4.

The relay station computer system 42 again can be arranged to control propulsion system and the transceiver positioning system as described above with the aim of use of the desired satellites 1a′, 1a″.

Having the modules 4a which may be separated from one another, moved relative to one another and which each have one or more satellite transceiver 41a, 41b can provide other options for selection in the aim of obtaining use of the desired satellites 1a′, 1a″.

Thus the relay station computer system 42 may be arranged under the control of software to select which transceivers 41a, 41b are used on which of the modules 4a in the relay function of the relay station 4′. Again this may be carried out dynamically, and may be carried out using a model based approach and/or a feedback loop based approach as outlined above.

Of course the relay station 4′ might handle traffic being passed between different start and end points, and the relay station computer system 42 can be arranged under the control of software to select respective transceivers for different routes.

In yet a further development where there are multiple different relay stations 4′ available as in the arrangement of FIG. 6, one of the relay station computer systems 42 or another computer system (not shown) may act as a master for controlling which of the relay stations 4′ are used, in general, or for different traffic routes.

The present communication system may be made use of in a number of situations. The typical architecture will be to have an end user software application which either:
i) includes components to selectively make use of this communication system—ie to cause data which is intended for sending from “the first computer” to “the second computer”—say from US to the UK—and vice versa to be routed via the present communication system and hence via the relay station 4, or
ii) operates in an environment where all internet traffic is passed to the present communication system.

In the first case the end user software application may include code portions for determining whether data is to be sent via the relay station 4 or via a more conventional route—this may be determined in dependence on the type of data and/or the intended destination for the data. This software application or at least parts of this software application may operate on “the first computer”, the originating computer 2a, or another computer.

In the second case the present communication system may include a computer, which may be “the first computer”, the originating computer 2a, or another computer, arranged under the control of software to determine whether data is to be sent via the relay station 4 or via a more conventional route—this may be determined in dependence on the type of data and/or the intended destination for the data.

As will be appreciated the present communication system in effect re-directs internet traffic by taking data intended for a destination computer 3a and sending it using IP packets addressed to a respective IP address of the relay station 4. Thus one possible process for arriving at these first IP packets addressed to the IP address of the relay station 4, is to take initial IP packets addressed say to the IP address of the destination computer and re-address these to the IP address of the relay station 4, and transmit these along with further IP packets which include instructions on how to handle the packets. Another alternative is to extract the data from the initial IP packets and use this to generate the “first IP packets”. Yet another alternative is that the data which is to be sent to the destination computer 3a is identified before initial IP packets are created, in which case the first IP packets can be directly created including the payload data and requisite routing information.

As examples, the end user software application may, amongst other things, be:
i) calling software to facilitate an audio and/or video call between two users. In such a case there will be benefits in minimising latency in improving communication and user experience;
ii) gaming software in which the user is interacting with other gamers and/or a game engine which is located at a remote location. Similarly to case i) there will be benefits in minimising latency in improving communication and user experience;
iii) financial trading software in which information relevant to trades is transmitted and/or received, or moreover in which trade instructions are transmitted and/or received. Again due to the importance of having real-time information and/or executing trades as promptly as possible there can be gains in minimised latency.

In the case of situation iii) for example a first computer operating under the control of a first component of the end user software application at a first location, say London in UK, may be arranged to send information to a second computer operating under the control of a second component of the end user software application at a second location, say New York in the US, and this second computer may be arranged under control of the second component to execute a trade based on the received information.

Thus a computer operating under the control of a component of an end user software application at a second location, say New York in the US, may be arranged under control of the component to execute a trade based on the received information from a first location via the present communication system.

There are of course many other possible use cases, including remotely controlling devices, gathering information, transmitting information.

Sometimes the output of a computer operating under the control of an end user software application at a second location will be the display of information received information from a first location via the present communication system.

As mentioned in the introduction each computer or computer system mentioned above will be constituted by one or more physical computer device operating under the control of software and comprise conventional computer device components including at least a processor, memory and data storage.

1. A relay station for use in a communication system for transmitting data from a first computer to a second computer,
the relay station comprising at least two low earth orbit satellite transceivers which are arranged for communication with a plurality of low earth orbit satellites and a relay computer system arranged to relay signals received via a first of the at least two low earth orbit satellite transceivers from a first low earth orbit satellite in the plurality of low earth orbit satellites onto a second low earth orbit satellite in the plurality of low earth orbit satellites via a second of the at least two low earth orbit satellite transceivers;
wherein the relay computer system is arranged under the control of software to:
a) receive first IP packets carrying data items originating from the first computer via the first of the at least two low earth orbit satellite transceivers,
b) produce corresponding second IP packets carrying the respective data items but addressed to an IP address of the second computer, and
c) transmit the second IP packets via the second of the at least two low earth orbit satellite transceivers towards the second computer.

2. A relay station according to claim 1 in which the relay computer system is arranged to relay signals received via the second of the at least two low earth orbit satellite transceivers from a second low earth orbit satellite in the plurality of low earth orbit satellites onto the first low earth orbit satellite in the plurality of low earth orbit satellites via the first of the at least two low earth orbit satellite transceivers;
wherein the relay computer system is arranged under the control of software to:
a) receive third IP packets carrying data items originating from the second computer via the second of the at least two low earth orbit satellite transceivers,
b) produce corresponding fourth IP packets carrying the respective data items but addressed to an IP address of the first computer, and
c) transmit the fourth IP packets via the first of the at least two low earth orbit satellite transceivers towards the first computer.

3. A relay station according to claim 1 in which the relay station comprises a main body and a transceiver positioning system for positioning at least one of the low earth orbit satellite transceivers relative to the main body.

4. A relay station according to claim 3 in which the transceiver positioning system comprises at least one of:
a translational positioning mechanism for moving the at least one of the low earth orbit satellite transceivers translationally relative to the main body;
a rotational positioning mechanism for rotating the at least one of the low earth orbit satellite transceivers relative to the main body around a rotation axis; or
a tilt positioning mechanism for tilting the at least one of the low earth orbit satellite transceivers relative to the main body around a tilt axis.

5. A relay station according to claim 1 in which the relay station is arranged as a platform which is arranged to be provided in the ocean.

6. A relay station according to claim 1 in which the relay station is arranged as an autonomous vehicle.

7. A relay station according to claim 1 which further comprises a propulsion system for moving the relay station translationally relative to a surface on which it supported.

8. A relay station according to claim 1 which further comprises at least one solar panel for providing electrical power to components of the relay station.

9. A relay station according to claim 1 in which the relay station computer system comprises a first relay station computer and a second relay station computer, wherein, the first relay station computer is arranged for receiving signals acquired by the first of the at least two low earth orbit satellite transceivers and the second relay station computer is arranged for sending signals via the second of the at least two low earth orbit satellite transceivers, and
the IP address associated with the first of the at least two low earth orbit satellite transceivers is the IP address of the first relay station computer.

10. A relay station according to claim 1 in which the relay station computer system is arranged under the control of software to act as a central control system for controlling at least one of:
the transceiver positioning system; and
the propulsion system.

11. A relay station according to claim 10 in which the relay station computer system is arranged under the control of software to act as a central control system for controlling at least one of:
the transceiver positioning system,
the propulsion system,
so as to at least one of move and orient at least one of the low earth orbit satellite transceivers in dependence on a model of position versus time of the plurality of low earth orbit satellites in order to facilitate communication between the at least one of the low earth orbit satellite transceivers and a selected one of the low earth orbit satellites in preference to another of the low earth orbit satellites.

12. A relay station according to claim 10 in which the relay station computer system is arranged under the control of software to act as a central control system for controlling at least one of:
the transceiver positioning system;
the propulsion system,
so as to at least one of move and orient the first and second low earth orbit satellite transceivers in dependence on a model of position versus time of the plurality of low earth orbit satellites in order to:
i) facilitate communication between the first satellite transceiver and a first selected one of the low earth orbit satellites in preference to a second selected one of the low earth orbit satellites; and
ii) facilitate communication between the second satellite transceiver and the second selected one of the low earth orbit satellites in preference to the first selected one of the low earth orbit satellites.

13. A relay station according to claim 10 in which the relay station computer system is arranged under the control of software to act as a central control system for controlling at least one of:
the transceiver positioning system;
the propulsion system,
so as to at least one of move and orient at least one of the low earth orbit satellite transceivers by:
a) at a first time monitoring which ones of the plurality of low earth orbit satellites are used to send signals to and/or receive signals from the first satellite transceiver and the second satellite transceiver; and
b) at a second time at least one of moving and orienting at least one of the low earth orbit satellite transceivers when said monitoring reveals that signals were being sent to and/or received from the first satellite transceiver and the second satellite transceiver via the same low earth orbit satellite, said at least one of moving and orienting being specified with the aim of:
i) facilitating communication between the first satellite transceiver and a first selected one of the low earth orbit satellites in preference to a second selected one of the low earth orbit satellites; and
ii) facilitating communication between the second satellite transceiver and the second selected one of the low earth orbit satellites in preference to the first selected one of the low earth orbit satellites.

14. A relay station according to claim 1 in which the relay station comprises a plurality of relay station modules provided for use together as a relay station, with each relay station module comprising at least one of the satellite transceivers.

15. A communication system for transmitting data from a first computer to a second computer comprising:
a low earth orbit satellite communications system comprising a plurality of low earth orbit satellites arranged to communicate with each other and with ground based low earth orbit satellite transceivers;
a relay station comprising at least two low earth orbit satellite transceivers which are arranged for communication with the plurality of low earth orbit satellites and a relay computer system arranged to relay signals received via a first of the at least two low earth orbit satellite transceivers from a first low earth orbit satellite in the plurality of low earth orbit satellites onto a second low earth orbit satellite in the plurality of low earth orbit satellites via a second of the at least two low earth orbit satellite transceivers; wherein,
i) the relay station is disposed at a geographical location selected to facilitate reception of signals from the first low earth orbit satellite in the plurality of low earth orbit satellites via the first of the at least two low earth orbit satellite transceivers and transmission of signals to the second low earth orbit satellite in the plurality of low earth orbit satellites via the second of the at least two low earth orbit satellite transceivers;
ii) the first computer is arranged under the control of software to produce first IP packets carrying data items and addressed to an IP address associated with the first of the at least two low earth orbit satellite transceivers at the relay station;
iii) the relay computer system is arranged under the control of software to:
a) receive the first IP packets via the first of the at least two low earth orbit satellite transceivers,
b) produce corresponding second IP packets carrying the respective data items but addressed to an IP address of the second computer,
c) transmit the second IP packets via the second of the at least two low earth orbit satellite transceivers towards the second computer;
and
iv) the second computer is arranged to receive the second IP packets.

16. A first computer for use in a communication system for transmitting data from a first computer to a second computer, wherein the first computer is arranged under the control of software to produce first IP packets carrying data items for transmission to the second computer and addressed to an IP address associated with a relay station which is disposed in a communication channel between the first computer and the second computer and which is disposed at a geographical location selected to facilitate reception of signals from a first low earth orbit satellite via a first low earth orbit satellite transceiver at the relay station and transmission of signals to a second low earth orbit satellite via a second low earth orbit satellite transceiver at the relay station.

17. A method of receiving data at a second computer from a first computer, comprising the action of receiving second IP packets carrying data from a relay station which is disposed in a communication channel between the first computer and the second computer and which is disposed at a geographical location selected to facilitate reception of signals from a first low earth orbit satellite via a first low earth orbit satellite transceiver at the relay station and transmission of signals to a second low earth orbit satellite via a second low earth orbit satellite transceiver at the relay station, the second IP packets carrying data from the first computer having been received at the relay station via first IP packets.

18. A machine readable data carrier which comprises at least one machine readable physical media product and carries a computer program comprising code portions which when loaded and run on a computer device or set of computer devices cause the computer device or set of computer devices to constitute a relay station computer system of a relay station for use in a communication system for transmitting data from a first computer to a second computer,
wherein the relay station comprises at least two low earth orbit satellite transceivers which are arranged for communication with a plurality of low earth orbit satellites and the relay computer system arranged to relay signals received via a first of the at least two low earth orbit satellite transceivers from a first low earth orbit satellite in the plurality of low earth orbit satellites onto a second low earth orbit satellite in the plurality of low earth orbit satellites via a second of the at least two low earth orbit satellite transceivers;
and the relay computer system is arranged under the control of the computer program to:
a) receive first IP packets carrying data items originating from the first computer via the first of the at least two low earth orbit satellite transceivers,
b) produce corresponding second IP packets carrying the respective data items but addressed to an IP address of the second computer, and
c) transmit the second IP packets via the second of the at least two low earth orbit satellite transceivers towards the second computer.

19. (canceled)

20. (canceled)

21. A relay station according to claim 1 wherein the relay station is disposed at a geographical location selected to facilitate reception of signals from the first low earth orbit satellite in the plurality of low earth orbit satellites via the first of the at least two low earth orbit satellite transceivers and transmission of signals to the second low earth orbit satellite in the plurality of low earth orbit satellites via the second of the at least two low earth orbit satellite transceivers.
